(19) United States
(12) Patent Application Publication
(10) Pub. No.: US 2002/0073264 A1
(43) Pub. Date: Jun. 13, 2002

(54) Integrated co-processor configured as a PCI device

(76) Inventors: Varghese George, Folsom, CA (US); Vladimir Pentkovski, Folsom, CA (US); Deep Buch, Folsom, CA (US); Paul Zagacki, Citrus Heights, CA (US); Edward Gamsaragan, El Dorado Hills, CA (US)

Correspondence Address: John P. Ward, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/733,766

(22) Filed: Dec. 8, 2000

(51) Int. Cl. G06F 13/00; G06F 13/38; G06F 13/14

(52) U.S. Cl. 710/305

(57) ABSTRACT

An Integrated Co-Processor Configured as a PCI Device is described herein.

### DESCRIPTION OF RELATED ART

In order to drive cost and power lower while continuing to increase performance in today's computer systems, designers have relied on a number of methods, including the integration of discrete computer system components into the substrate of a core-logic chipset and/or microprocessor.

Device integration has been largely limited to the area of Accelerated Graphics Port (AGP) graphics. Computer systems are available today with core-logic chipsets containing integrated AGP graphics devices designed to operate at lower power, lower cost, and higher performance than some computer systems containing discrete AGP graphics devices. Moreover, recent advancements in computer system component integration has spawned the integration of AGP graphics within a microprocessor.

However, devices currently being integrated within a microprocessor or chipset, such as AGP graphics, do not maintain software compatibility with their discrete counterparts. Therefore, when integrating discrete devices into a microprocessor or chipset, designers may have to develop new device software, thereby increasing development cost and time to market.

### BRIEF DESCRIPTION OF THE FIGURES

FIG. 1 illustrates one embodiment in which a co-processor is integrated within a microprocessor substrate.

FIG. 2 illustrates a data read cycle issued by a CPU core to an integrated co-processor.

FIG. 3 illustrates a data write cycle issued by a CPU core to an integrated co-processor.

### DETAILED DESCRIPTION

The present invention provides a method and apparatus for integrating at least one co-processor within the same semiconductor substrate as at least one CPU core. In one embodiment, this is accomplished by configuring the integrated co-processor as a Peripheral Component Interconnect (PCI) device, thereby enabling software written for a similar discrete PCI device to be used on integrated co-processors of the same type. However, the present invention is not limited to the integration of a PCI device within a microprocessor substrate. Rather, one of ordinary skill in the art would appreciate that the method and apparatus disclosed herein could be used to implement the integration of a PCI device within other computer system components, such as a core-logic chipset.

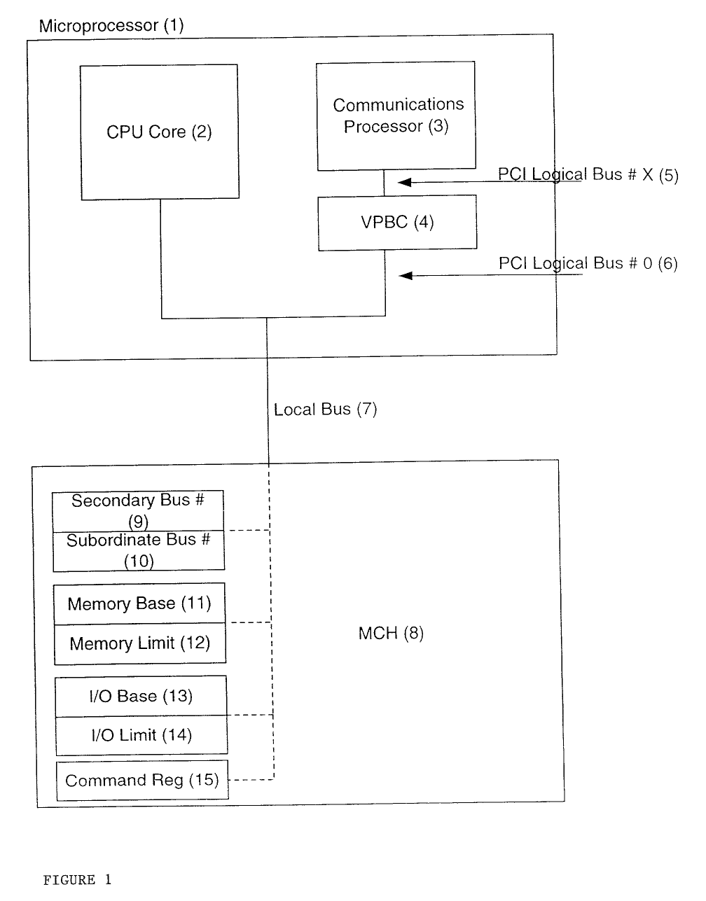

FIG. 1 is a block diagram of one embodiment in which a communications processor 3 is integrated within the microprocessor substrate 1 along with a CPU core 2 and a Virtual PCI-to-PCI Bridge Circuit (VPBC) 4. In this embodiment, the VPBC provides a virtual PCI interface between the local bus 7 and the communications processor, such that local bus cycles containing PCI addresses intended for the communications processor may be properly recognized and received by the communications processor within the local bus protocol. Likewise, the VPBC drives PCI addresses originating from the communications processor onto the local bus in a manner commensurate with the local bus protocol. In the above embodiment, the VPBC exists on PCI Logical Bus #0 6. However, the VPBC may exist on other logical busses and is not limited to the logical bus illustrated in FIG. 1.

In one embodiment, address and command data originating from the CPU core or other device are compared against a set of configuration registers within the VPBC and MCH 8. If an address falls within the range of addresses stored within the configuration registers, the VPBC and MCH coordinate a response to the device from which the address originated. In this embodiment, a duplicate set of configuration registers 9-15 contained within the MCH are contained within the VPBC. Therefore, the MCH and the VPBC may determine whether an address driven onto the local bus is intended for the communications processor or some other device within the system.

The configuration registers illustrated in FIG. 1 include PCI address registers and PCI command registers. In one embodiment, these registers consist of secondary and subordinate bus registers, 9 and 10 respectively, which contain the range of PCI bus numbers upon which at least one integrated co-processor resides. The configuration registers are filled with appropriate PCI configuration data by existing PCI enumeration and configuration methods that are well known by one of ordinary skill in the art. One such set of configuration data consist of a range of PCI bus numbers as illustrated in FIG. 1 by PCI Logical Bus #X 5. The configuration registers further consist of a PCI memory base and limit, 11 and 12 respectively, as well as a PCI input/output (I/O) base and limit, 13 and 14 respectively. Lastly, the configuration registers contain at least one PCI command register 15. By comparing command and address data originating from devices such as a CPU core with the contents of these configuration registers within the MCH and VPBC, the MCH and VPBC determine whether the address and command data are intended for an integrated co-processor, such as a communications processor.

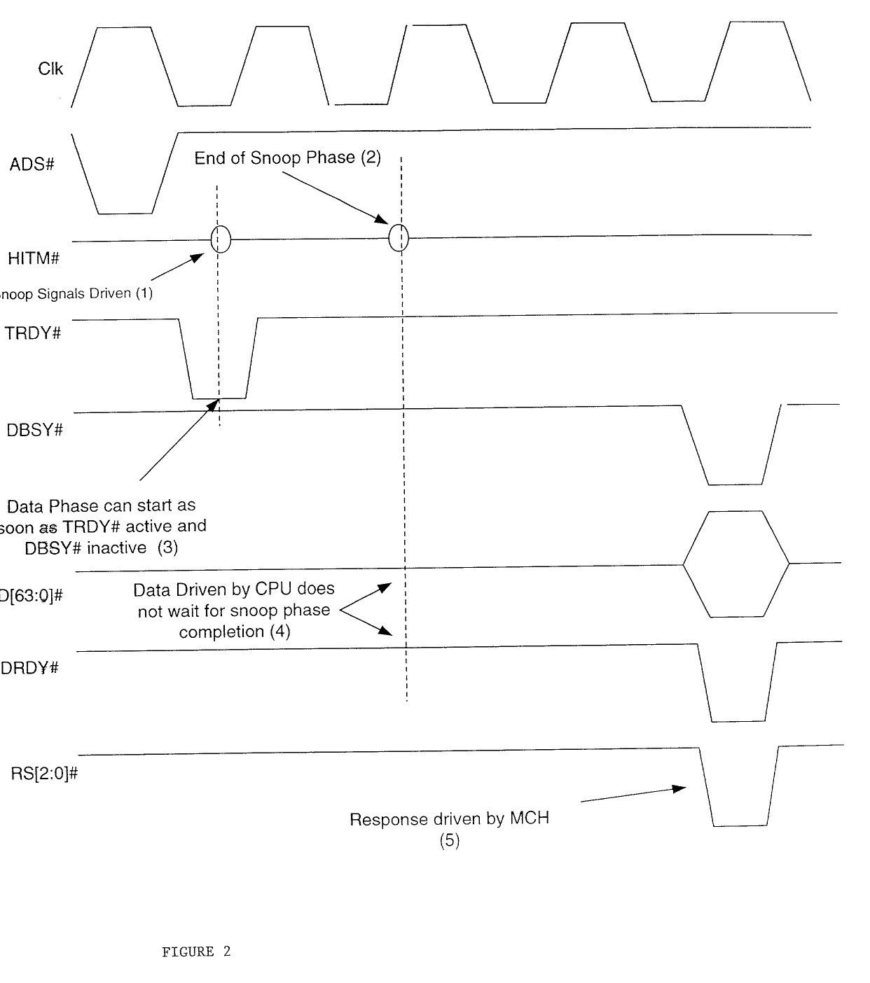

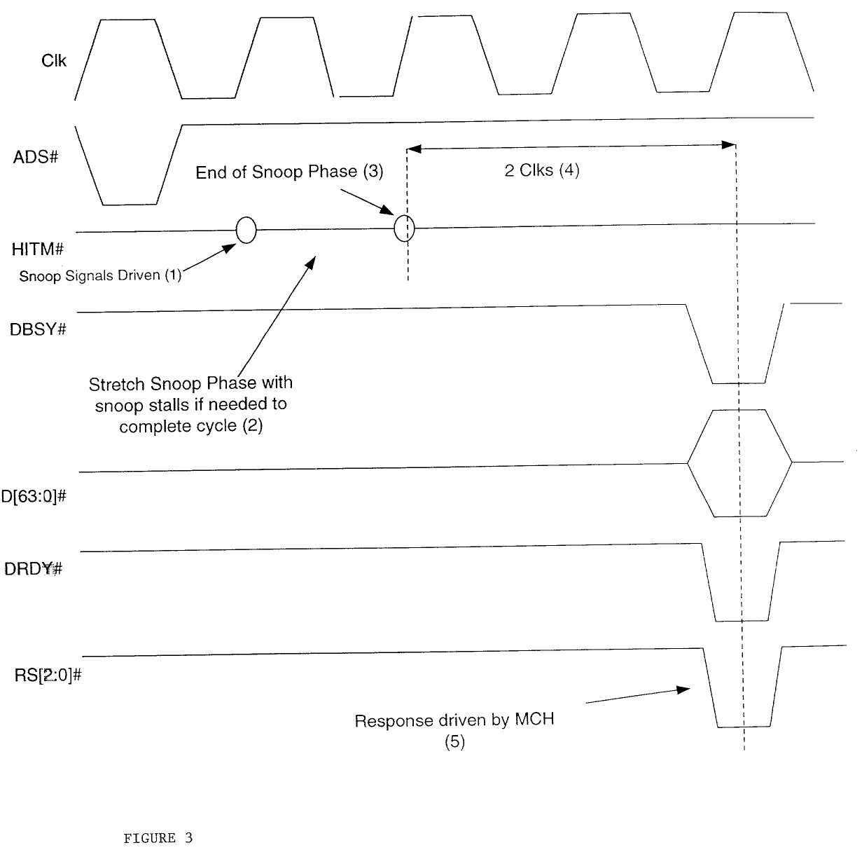

Once the determination is made by the VPBC and MCH that an address is intended for the integrated co-processor, a response is coordinated by the VPBC and MCH as illustrated in one embodiment by FIGS. 2 and 3. In FIG. 2, a read cycle, in accordance with one embodiment, is illustrated in which the VPBC initiates a snoop phase 1 after detecting an address strobe on the local bus. Two cycles 4 after the snoop phase has ended 3, the VPBC drives the requested data onto the local bus. Alternatively, the VPBC may stall 2 the requesting device if more than two bus cycles are needed to retrieve the requested data. The read cycle is then completed by asserting RS[2:0] 5 from the MCH. If the asserted address does not fall within one of the ranges of PCI configuration registers and is therefore not intended for the communications processor, the VPBC will ignore the read cycle and the MCH will forward the request to the intended device.

FIG. 3, similarly illustrates a timing diagram of one embodiment in which an integrated co-processor, such as a communications processor, receives a write bus cycle from a CPU core. In this embodiment, the VPBC issues a snoop phase 1 upon detecting an address strobe on the local bus. However, in the write cycle case, data may be driven 4 onto the local bus prior to the end of the snoop phase 2. In fact, data may be driven as soon as the MCH asserts the TRDY# signal 3. As in the case of a read bus cycle, the MCH indicates the end of the write data cycle by asserting RS[2:0] 5. Similar to the read bus cycle case, if the asserted address does not fall within one of the ranges of PCI configuration registers and is therefore not intended for the communications processor, the VPBC will ignore the write data cycle and the MCH will forward the request to the intended device.

The integrated communications processor embodiment described is one example of that which is disclosed in the invention. One of ordinary skill in the art would recognize and appreciate that the disclosed invention is not limited to the integration of a communications processor, nor is it limited to a co-processor integrated within the microprocessor substrate. Rather, the method and apparatus disclosed may be applied to the integration of any PCI device within other computer system components, such as a microprocessor or a core-logic chipset.

What is claimed is:

1. A microprocessor comprising:
at least one CPU core;
at least one co-processor;
at least one bridge circuit coupling said at least one CPU core and at least one external bus agent to said at least one co-processor.

2. The microprocessor of claim 1 wherein said at least one co-processor is configured as a PCI device.

3. The microprocessor of claim 2 wherein said at least one bridge circuit is a virtual PCI-to-PCI bridge circuit (VPBC).

4. The microprocessor of claim 3 wherein said VPBC comprises an initiator circuit and a response circuit.

5. The microprocessor of claim 4 wherein said initiator circuit initiates bus cycles on behalf of said at least one co-processor.

6. The microprocessor of claim 5 wherein said response circuit responds to bus cycles addressed to said at least one co-processor, said response being coordinated with said at least one external bus agent.

7. The microprocessor of claim 6 wherein said at least one co-processor is a communications processor.

8. The microprocessor of claim 7 wherein said at least one external bus agent is a memory controller hub (MCH).

9. The microprocessor of claim 6 wherein said VPBC further comprises:
at least one set of configuration registers, said at least one set of configuration registers containing a range of addresses corresponding to a PCI bus number associated with said at least one co-processor, a memory-mapped address space corresponding to said at least one co-processor, an I/O address space corresponding to said at least one co-processor, and command register corresponding to said at least one co-processor.

10. The microprocessor of claim 9, wherein said MCH comprises shadow registers, said shadow registers containing information contained within said at least one set of configuration registers.

11. A method comprising the steps of:
Initiating a bus operation by a first bus agent;
Determining whether a second bus agent is addressed by said bus operation, said determining being performed by a third and fourth bus agent;
Coordinating a response to said first bus agent between said third and fourth bus agents.
Responding to said first bus agent, said response being communicated by said third and said fourth bus agents.

12. The method of claim 11 wherein said response to said first bus agent depends upon whether said second bus agent was addressed by said first bus agent and upon the type of said bus operation initiated by said first bus agent.

13. The method of claim 12 wherein said determining comprises:
a comparison by said third bus agent of a target address associated with said bus operation with the contents of a first set of configuration registers stored within said third bus agent;
a comparison by said fourth bus agent of the target address associated with said bus operation with the contents of a second set of configuration registers stored within said fourth bus agent, said contents of said second set of configuration registers containing information contained within said first set of configuration registers.

14. The method of claim 13 wherein said first and second sets of configuration registers contain:
a range of addresses corresponding to a PCI bus number associated with said second bus agent;
a range of addresses corresponding to a memory-mapped address space, said memory-mapped address space corresponding to said second bus agent;
a range of addresses corresponding to an I/O address space, said I/O address space corresponding to said second bus agent;
a register for storing commands corresponding to said second bus agent.

15. The method of claim 14 wherein said response comprises:
Returning data addressed by said first bus agent to said first bus agent from said third bus agent if said bus operation is a read operation;
Storing data received from said first bus agent within said third bus agent if said bus operation is a write operation, said step of storing further comprises indicating to said first bus agent whether said write buffers are one entry less than full;
Indicating the completion of said response to said first bus agent, said indicating being performed by said fourth bus agent.

16. The method of claim 15 wherein the step of returning data further comprises a snoop operation, said snoop operation being performed by said third bus agent at least two clock cycles prior to returning said data.

17. The method of claim 16 wherein the step of storing write data further comprises said indicating to said first bus agent whether said data may be driven onto the bus, said indicating being performed by said fourth bus agent.

18. A system comprising:
at least one microprocessor, said at least one microprocessor comprising at least one CPU core, at least one co-processor, and at least one bridge circuit;
an external bus agent, said external bus agent being coupled to said at least one microprocessor.

19. The system of claim 18 wherein said at least one co-processor is configured as a PCI device.

20. The system of claim 19 wherein said at least one bridge circuit is a virtual PCI-to-PCI bridge circuit (VPBC).

21. The system of claim 20 wherein said at least one co-processor is a communications processor.

22. The system of claim 21 wherein said at least one external bus agent is a memory controller hub (MCH).
